(19) United States
(12) Patent Application Publication
(10) Pub. No.: US 2009/0129238 A1
(43) Pub. Date: May 21, 2009

(54) OBJECTIVE LENS

(76) Inventors: Takeshi Shimano, Moriya (JP); Masaki Mukoh, Tsukuba (JP)

Correspondence Address: MATTINGLY & MALUR, P.C., 1800 DIAGONAL ROAD, SUITE 370, ALEXANDRIA, VA, 22314, US

(21) Appl. No.: 12/188,297

(22) Filed: Aug. 8, 2008

(30) Foreign Application Priority Data
Nov. 19, 2007 (JP) 2007-299065

(51) Int. Cl. G11B 7/135

(52) U.S. Cl. 369/112.23; G9B/7.112

(57) ABSTRACT

A combined aspherical lens has an aspherical shape with an intermediate substrate thickness between the substrate thicknesses of a BD and an HD in a numerical aperture (NA) range for the HD, and an aspherical shape dedicated to the BD in an NA range for the BD only. The lens is designed such that wave aberration occurring through the NA range for the HD for BD reproduction has the same aberration form as but has an opposite sign to wave aberration occurring through this range for HD reproduction. Further, in the NA range for the HD, a pattern of annular transparent electrodes is optimized for a spherical aberration wavefront defocused to minimize the maximum inclination of the wave aberration. A phase shift applied is within plus or minus half wave excluding an integer wavelength of aberration.

### CLAIM OF PRIORITY

The present application claims priority from Japanese patent application JP 2007-299065 filed on Nov. 19, 2007, the content of which is hereby incorporated by reference into this application.

### BACKGROUND OF THE INVENTION

1. Field of the Invention

The present invention relates to an objective lens for an optical disc pickup and more particularly to a compatible objective lens capable of performing reproduction, using a single wavelength, from optical discs of two kinds of standards having different substrate thicknesses or recording densities.

2. Description of the Related Art

Optical discs such as a CD (compact disc) and a DVD (digital versatile disc) have been originally intended mainly for applications for distribution of reproduce-only music and video contents, but are now in wide use also as recordable media capable of recording such as dubbing and video recording. Further, with a total changeover in 2011 from terrestrial analog television broadcasting to digital television broadcasting coming up, a large-screen and low-profile display is becoming increasingly widespread, and thus, there is a growing need for HDTV (high-definition television) video recording. Against such a background, large-capacity optical discs such as Blu-ray Disc (hereinafter called “BD”) and HD DVD (hereinafter called “HD”) are released as recording media on the market, and there are also released an increasing number of reproduce-only video contents.

The BD is an optical disc medium on which a laser beam with a wavelength of 405 nm from a blue-violet laser diode is focused through an objective lens with a numerical aperture (NA) of 0.85 to thereby perform signal reproduction. The wavelength for the BD is shorter by a factor of about 0.6 than a wavelength of 650 nm for the DVD, and the NA for the BD is larger by a factor of 1.4 than an NA of 0.6 for the DVD, so that the storage capacity of the BD is 25 GB per layer, which is larger by a factor of about 5 than that of the DVD. Meanwhile, the BD includes a transparent substrate for preventing the disc from being affected by the adhesion of dust or dirt. In order to suppress an increase in aberration caused by the tilt of the disc even with such a large NA for the BD, the thickness of the transparent substrate for the BD is made as thin as 0.1 mm, which is less than a thickness of 0.6 mm of a transparent substrate for the DVD.

On the other hand, the BD requires a different manufacturing process and manufacturing apparatus from those for the DVD, because of having a very high recording density and also having a transparent substrate whose thickness is very small on the light incident side thereof. For this reason, from early on, it has been pointed out that media makers encounter the problem of an increase in manufacturing costs including plant and equipment investment. Thus, an HD standard has been created as coexisting with a BD standard, and the HD standard is based on the condition that the HD can be manufactured by use of the same manufacturing apparatus as that for the DVD. Consequently, two types of essentially incompatible media have been developed and released at substantially the same time. For the HD, the laser beam with a wavelength of 405 nm from the blue-violet laser diode is used as in the case of the BD. However, an objective lens with an NA of 0.65 is used to focus a light beam on a recording film through a substrate with a thickness of 0.6 mm that is the same as that of the DVD. The storage capacity of the HD is 15 GB per layer.

Development of an optical disc unit compatible with both the BD and the HD has also been announced on the Internet or the like in order to prevent confusion in the market due to the coexistence of these two types of media. In this development, a configuration is such that two lenses, namely, a BD dedicated lens and an HD lens, are mounted on a lens actuator. An existing example having such a configuration is disclosed for instance in Japanese Patent Application Publication No. Hei 9-198677 (Patent Literature 1). This pertains to DVD/CD-compatible reproduction, in which light from a red laser diode is used in switching between a DVD dedicated lens and a CD dedicated lens mounted on a rotatable dual-lens actuator so as to correspond to DVD reproduction and CD reproduction.

Today, an optical pickup for the DVD reproduction is equipped with both a red laser diode and an infrared laser diode having a wavelength of 780 nm, and the infrared laser diode is used for the CD reproduction. This is based on the purpose of reproducing information on a CD-R (CD recordable) disc having the reflectivity property in which the reflectivity markedly decreases with wavelengths of red light, so that only infrared light is capable of CD-R reproduction. Thus, an existing DVD pickup uses a compatible reproduction method utilizing the fact that a wavelength for the DVD reproduction is basically different from that for the CD reproduction. However, studies have been originally made on a DVD/CD-compatible reproduction method using a single wavelength of red light, because the CD-R reproduction has not yet become indispensable in the early stages of DVD development. Thus, the compatible reproduction method using the single wavelength studied in the early stages of the DVD development can possibly be applied to an issue on BD/HD-compatible reproduction using a light source with a single wavelength of blue light, which is to be solved by the present invention.

Another existing example aiming at the reproduction compatibility is disclosed for instance in Japanese Unexamined Patent Application Publication No. Hei 7-98431 (Patent Literature 2). In this example, for the DVD/CD-compatible reproduction, a hologram element, which transmits one part of light from a red laser diode to form a beam of zero-order light, while diffracting the other part thereof to form a beam of first-order diffracted light, is formed integrally with an objective lens; a part of the lens other than the hologram element has an optimized shape for the DVD such that the lens can focus the zero-order light on the DVD; and the hologram element has a grating pattern for the CD such that the diffracted light can compensate for spherical aberration caused by a difference in substrate thickness between the CD and the DVD. This makes it feasible to achieve reproduction compatibility using a single wavelength between two types of optical discs of different substrate thicknesses and NAs.

Also, Japanese Patent Application Publication No. Hei 9-17023 (Patent Literature 3) discloses the technique of compensating spherical aberration caused by a difference between the substrate thicknesses of the CD and the DVD in the following manner. Specifically, light from a red laser diode is collimated by a collimator lens to form substantially parallel rays and the rays thus formed enter an objective lens. The distance between the laser diode and the collimator lens at this time is made variable so that different distances can be set for the CD and the DVD, respectively. Use of the different distance allows a change in the divergence of the light entering the objective lens. Japanese Patent Application Publication No. Hei 9-184975 (Patent Literature 4) discloses an approach of using a lens including a central portion around the optical axis in the center of the lens, and a peripheral portion. The central portion has a range required as NAs for the CD and has a lens form optimized for an intermediate substrate thickness between the substrate thicknesses of the DVD and the CD, while the peripheral portion has a lens form optimized for the DVD only. Further, the use of a liquid crystal device for compensation for spherical aberration is disclosed for instance in Japanese Patent Application Publication No. 2005-257821 (Patent Literature 5). Here disclosed is a general spherical aberration compensation method using a liquid crystal, which is not necessarily limited to compensating for the spherical aberration caused by the difference in substrate thickness between two types of optical discs.

### SUMMARY OF THE INVENTION

It cannot be necessarily said that any of the above existing techniques is sufficient for use for achieving compatibility between BD and HD. If an attempt is made to apply the technique disclosed in Patent Literature 1 to attain the compatibility between BD and HD, switching between BD dedicated and HD dedicated objective lenses is done for use, which in turn is ideal as optical performance capabilities. However, the mounting of the two lenses to an actuator leads to a heavyweight moving part and thus to insufficient following performance in focusing servo control and tracking servo control, so that there remains a problem in increasing a data transfer rate. Moreover, with the actuator serving as both tracking servo control operation and rotating operation for lens switching, the locus of lens movement involved in the tracking servo control is in the form of an arc, which in turn causes a deviation of the position of a focusing spot on a photodetector or other problems, in a situation where a diffractive element or the like is used to split light and focus the split light on the photodetector or in other situations. Further, the size of the disc unit becomes large, thus making it difficult to apply this technique to miniaturization required for a slim drive or the like.

If an attempt is made to apply the technique disclosed in Patent Literature 2 to attain the compatibility between BD and HD, the utilization of the hologram element makes it possible to achieve optically ideal wave accuracy for both the BD and the HD. However, a focusing spot for the BD and a focusing spot for the HD appear at all times, and thus, regardless of whichever disc may be reproduced, the focusing spot for the disc not being subjected to reproduction is present as undesired stray light. For example in the case of reproduction on a dual layer disc or in other cases, such light can possibly become a factor that produces a larger amount of stray light, thus may cause an unexpected interference effect or the like, and thereby may cause disturbance to get mixed in a reproduced signal. Further, there occur losses of spot light quantity for the HD during BD reproduction and spot light quantity for the BD during HD reproduction, respectively, which in turn presents the problem of reducing the utilization efficiency of light.

If an attempt is made to apply the technique disclosed in Patent Literature 3 to attain the compatibility between BD and HD, the collimator lens is moved so that the degree of divergence of light incident on the objective lens for BD reproduction may vary from that for HD reproduction to thereby compensate for the spherical aberration. If an optical design for this configuration is performed with sufficient precision, optically ideal wave accuracy can be achieved. However, the NA for the BD and HD is larger than that for the DVD and CD, and thus, the spherical aberration to be compensated for is greater in proportion to the fourth power of the NA. If, with such spherical aberration compensated for, the objective lens moves relative to the optical axis of the collimator lens for purposes of the tracking servo control operation, coma aberration which occurs along with the movement of the lens cannot be ignored.

If an attempt is made to apply the technique disclosed in Patent Literature 4 to attain the compatibility between BD and HD, an aspherical shape in the NA range for HD reproduction has to be a shape that offers a compromise between the BD dedicated lens and the HD dedicated lens. In this instance, there exists a problem as given below: both the BD and the HD are originally designed as the optical discs on which reproduction takes place at wavelengths of blue-violet light; thus, a required NA ratio between the two optical discs between which compatibility is to be provided is larger than that for the DVD/CD-compatible reproduction in which the CD originally designed for reproduction at a wavelength of 780 nm undergoes reproduction at a wavelength of 650 nm so that the required NA for CD reproduction can be reduced to less than 0.45, thereby resulting in an increase in residual aberration.

The use of the liquid crystal device for attaining the compatibility between BD and HD as disclosed in Patent Literature 5 is effective for the miniaturization that becomes the problem with the technique disclosed in Patent Literature 1. Moreover, the technique disclosed in Patent Literature 5 can solve the problem of the stray light with the technique disclosed in Patent Literature 2, because of actively compensating for the wavefronts of the BD and the HD. Further, the technique disclosed in Patent Literature 5 can eliminate the influence of the coma aberration caused by the lens shift, which becomes the problem with the technique disclosed in Patent Literature 3, provided that the liquid crystal device is formed integrally with the objective lens. The technique disclosed in Patent Literature 5 can also basically resolve the problem with the technique disclosed in Patent Literature 4 by providing active compensation for aberration. However, if the liquid crystal is used to provide the compatibility between BD and HD, the amount of aberration to be compensated for is very large, and thus, it is required that electrodes be very finely made and a phase shift vary very widely in order to achieve sufficient aberration performance. Finer annular transparent electrode leads to a larger number of lead wires therefrom, thus resulting in the problem of increasing the area of a region within a range of an effective pupil diameter, which cannot contribute to the occurrence of the phase shift. Moreover, the transparent electrode of too narrow a width is difficult to fabricate and also can possibly be unable to achieve sufficient voltage application characteristics. Further, an increase in the thickness of a liquid crystal layer for purposes of an increase in the phase shift to be applied involves the problems of slowing down responses and increasing power consumption.

In view of the foregoing problems, an object of the present invention is to minimize the amount of aberration to be compensated for, and also to prevent the width of the electrode from becoming too narrow and thereby to minimize the area of the region occupied by the lead wires from the electrodes, when the liquid crystal device or the like is formed integrally with the objective lens to achieve the compatibility between BD and HD.

In order to attain the above object, the present invention uses an objective lens including an aspherical shape employed to compensate for spherical aberration for an intermediate substrate thickness between a substrate thickness of a disc requiring a small NA and having a great substrate thickness and a substrate thickness of a disc requiring a large NA and having a small substrate thickness, in a range of the small NA; and an aspherical shape employed to compensate for spherical aberration for the small substrate thickness outside the range of the small NA and within a range of the large NA, as disclosed in Patent Literature 4. The objective lens further includes a means having an annular region that effects a phase shift so that the phase shift may be m/n of the wavelength (where n denotes a natural number that satisfies the following equation: n≧2, and m denotes an integer that satisfies the following equation: |m|≦n/2), the means for changing the sign of the phase shift so that the sign for one of two types of optical discs can be substantially opposite to that for the other.

Japanese Patent Application Publication No. Hei 10-255305, for instance, discloses that the lens having a nonuniform aspherical shape as mentioned above is provided with a phase shifter. However, in this existing example, a phase shift for reproduction on one of two types of optical discs is different from that for the other, provided that the wavelength of a laser diode for reproduction on the one optical disc is different from that for the other, whereas, in the present invention, a single wavelength of the laser diode is used for reproduction on two types of optical discs. Thus, the absolute value of the phase shift for one of the optical discs is approximately the same as that for the other, and the sign of the phase shift for the one optical disc is merely opposite to that for the other, provided that the phase shift is basically actively changed. Thereby, spherical aberration on two types of optical discs can be compensated for by a phase shift of plus or minus half wave by a single electrode pattern of the liquid crystal device.

Also, according to one aspect of the present invention, the n value is set particularly to 2. Thereby, the phase shift is limited to the plus or minus half wave. The phase shift is to effect a change in the phase of a light wave having undulation properties, and, if there is no change in intensity distribution, the phase shift of a single wavelength (generally, an integer wavelength within a coherence length) has the property equivalent to that it effects substantially no change. Accordingly, for example if the phase shift of plus half wave is given to one of two types of optical discs to reduce aberration, this is substantially equivalent to the phase shift of minus half wave. The reason is that +½−(−½)=1, and the difference in the amount of phase shift between the phase shift of plus half wave and the phase shift of minus half wave is one wavelength. If the lens having an aspherical shape employed to compensate for spherical aberration for an intermediate substrate thickness between two types of substrate thicknesses, as defined in claim 1, is used for reproduction on optical discs of these substrate thicknesses, the absolute value of spherical aberration that occurs on one of the optical discs is the same as that on the other, and the sign of the spherical aberration on the one optical disc is different from that on the other. Thus, the phase shifter of half wave in which the phase shift of plus half wave is substantially equivalent to the phase shift of minus half wave is effective for such aberrations of different signs. In this instance, the function of changing the sign of the phase shift for two types of optical discs, as defined in claim 1, is characterized by not requiring an active device such as the liquid crystal device. However, this is insufficient for the compatibility between BD and HD although having the effect, and, in addition to this, it is required that a phase shift of less than plus or minus half wave be used in combination.

Also, according to one aspect of the present invention, the phase shift is induced by a liquid crystal device. Thereby, the amount of phase shift is not limited to the plus or minus half wave as mentioned above, and a finer phase step can be given at different values for the optical discs, so that the effect of aberration compensation can be further enhanced.

According to another aspect of the present invention, the phase shift is induced by a combination of a liquid crystal device and any one of a step structure and a graded index device that effects a phase shift of plus or minus half wave, whereby the amount of phase shift to be applied by the liquid crystal device can be reduced. Depending on the step structure or the graded index device, the amount of phase shift is limited to the plus or minus half wave; however, by combination with an active phase shift, the range of phase shift can be a fine phase shift step of less than plus or minus half wave, and also, the amount of active phase shift can be reduced to less than plus or minus quarter wave. The reason is that a phase shift of ⅜ wave that lies between the quarter wave inclusive and the half wave exclusive, for example, can be used in combination with a passive phase shift of half wave to achieve an active phase shift of minus quarter wave, as given by ½−¼=⅜. The ability to narrow a voltage range for phase shift by the liquid crystal device enables reducing the number of signal voltages applied, and thus achieving the effect of reducing the number of wires for mounting of the objective lens to the lens actuator.

According to another aspect of the present invention, multiple transparent electrodes of the liquid crystal device are annularly formed, and an annular electrode of the greatest width, exclusive of the electrodes at the center and outside the NA range of the small NA, is present in a radial location that lies between 80% and 100%, both inclusive, of the NA range required for the disc reproduced at a spot of the small NA. The form of wave aberration including spherical aberration is generally expressed by W(ρ)=W₄₀ρ⁴+W₂₀ρ² using pupil radius coordinates ρ obtained by normalizing an effective pupil radius of the objective lens with 1, where W₄₀ and W₂₀ represent spherical aberration and a Seidel aberration coefficient indicative of the amount of defocus, respectively. The amount of defocus can be actually controlled by varying the offset of focusing servo control, since the amount of defocus is changed by varying a focal point of a spot focused on the optical disc.

In order that the liquid crystal device or the like is used to effect a phase shift and compensate for such wave aberration, different phase shifts can be applied to annular regions divided concentrically with respect to the optical axis to fold the aberration within a range of a required peak-to-peak value (hereinafter also referred to as “p-p value”) Wₗᵢₘᵢₜ. At this time, as the degree of inclination of wavefront is greater, the width of the transparent electrode required to fold the aberration within the range of Wₗᵢₘᵢₜ is narrower. The electrode of narrow width makes it difficult to fabricate the electrode and also increases the likelihood of an error with respect to a required desired phase distribution occurring due to an electric field leaking from the electrode. Thus, the amount of defocus can be such that the maximum value of the absolute value of first-degree differentiation by ρ of W(ρ) can be the smallest, in consideration for the amount of defocus that maximizes the width of the electrode. As will be described later, at this time, the wavefront is in a form such that the extreme value may be in a radial location that lies between 80% and 100%, both inclusive, of the aperture. In a location where the compensation wave aberration profile is the extreme value, the width of the transparent electrode is the greatest, so that the electrode of the greatest width, exclusive of the electrodes at the center and outside the range of the numerical aperture for the HD, is present in a radial location that lies between 80% and 100%, both inclusive, of the aperture.

Typically, the defocus is such that the overall RMS (root mean square) value can be the smallest in order to minimize the amount of aberration compensation, and at this time, ρ=\sqrt{2/2}≈0.7, which is about 70% of the aperture. Thus, when wave aberration is compensated for in a defocus state such that the wavefront may be the peak in a radial location toward the outer periphery relative to this position, the narrowest width of the annular electrode for the same peak-to-peak value of wave aberration can become greater. Further, this enables minimizing the occurrence of coma aberration when the liquid crystal device is offset from a lens portion. The reason is that residual aberration on misalignment between the wavefront to be compensated for and the phase shift for compensation is proportional to the product of the first-degree differentiation of the wavefront to be compensated for and the misalignment. In other words, the form of the wavefront that minimizes the first-degree differentiation of the wavefront enables reducing the sensitivity to the occurrence of residual aberration on the misalignment.

In order to apply a voltage outside a pupil diameter to the annular transparent electrode, it is desired that the region occupied by the lead wires to be wired to the transparent electrodes on the liquid crystal device within the pupil diameter be minimized. Thus, according to one aspect of the present invention, the layout is such that wiring may be common to multiple annular electrodes to which the same voltage is to be applied. Specifically, multiple transparent electrodes are annularly formed; a first node electrode that provides a substantially radial, linear junction between a first annular electrode and a second annular electrode disposed outside the first annular electrode, respectively, in proximity to each other, to which the same voltage is to be applied, the first node electrode being laid out through a broken portion provided in a third annular electrode interposed between the first and second annular electrodes, the third annular electrode being to which a different voltage from that for the first and second annular electrodes is to be applied; a second node electrode that provides a junction between the third annular electrode and a fourth annular electrode disposed in proximity to the third annular electrode and outside the second annular electrode, to which the same voltage as that for the third annular electrode is to be applied, the second node electrode being laid out through a broken portion provided in the second annular electrode and is disposed substantially parallel to and adjacent to the first node electrode; and thereafter, in the same manner, a junction is provided between multiple annular electrodes to which the same voltage is to be applied, while the transparent electrode is disposed in the liquid crystal device so that wires may be led out outside a region that transmits light. Thereby, the annular electrodes to which the same voltage is to be applied are laid out like a picture drawn without lifting the brush from the paper, so that the number of electrodes finally led out is equal to the number of applied voltages.

The present invention enables minimizing the amount of aberration to be compensated for, and also preventing the width of the electrode from becoming too narrow and thereby minimizing the area of the region occupied by the lead wires from the electrodes, when the liquid crystal device or the like is formed integrally with the objective lens to achieve the compatibility between BD and HD.

### BRIEF DESCRIPTION OF THE DRAWINGS

FIGS. 1A and 1B are views showing a basic embodiment of the present invention.

FIG. 2 is a plot showing wave aberration that occurs in an NA range for HD when an aspherical lens of the present invention is used for BD reproduction, with a defocus as a parameter.

FIG. 3 is a table showing the narrowest width of an electrode and the quantity of divisions of electrodes of a liquid crystal device that provides compensation for a wavefront shown in FIG. 2.

FIGS. 4A to 4C show spherical aberration wavefront at a best focus, a phase shift induced by a liquid crystal device that compensates for it, and wavefront after compensation.

FIGS. 5A to 5C show compensation wavefront by the liquid crystal device of the present invention, a compensation phase shift induced by the liquid crystal device, and wavefront after compensation.

FIGS. 6A and 6B are a schematic figure of layout of electrodes and a schematic figure of one of the electrodes, respectively, according to the present invention.

FIG. 7 is a sectional view of the liquid crystal device of the present invention.

FIG. 8 is a perspective view of the liquid crystal device of the present invention.

FIG. 9 is an exploded view of the liquid crystal device of the present invention.

FIGS. 10A and 10B are views showing a second embodiment of the present invention.

FIGS. 11A and 11B are graphs showing the effect of wave aberration compensation for BD/HD reconstruction by a phase step of half wave.

FIGS. 12A and 12B are graphs showing the amount of phase shift by the liquid crystal combining with a step structure according to the second embodiment of the present invention.

### DESCRIPTION OF THE PREFERRED EMBODIMENTS

Best modes for carrying out the present invention will be described below with reference to the drawings.

### First Embodiment

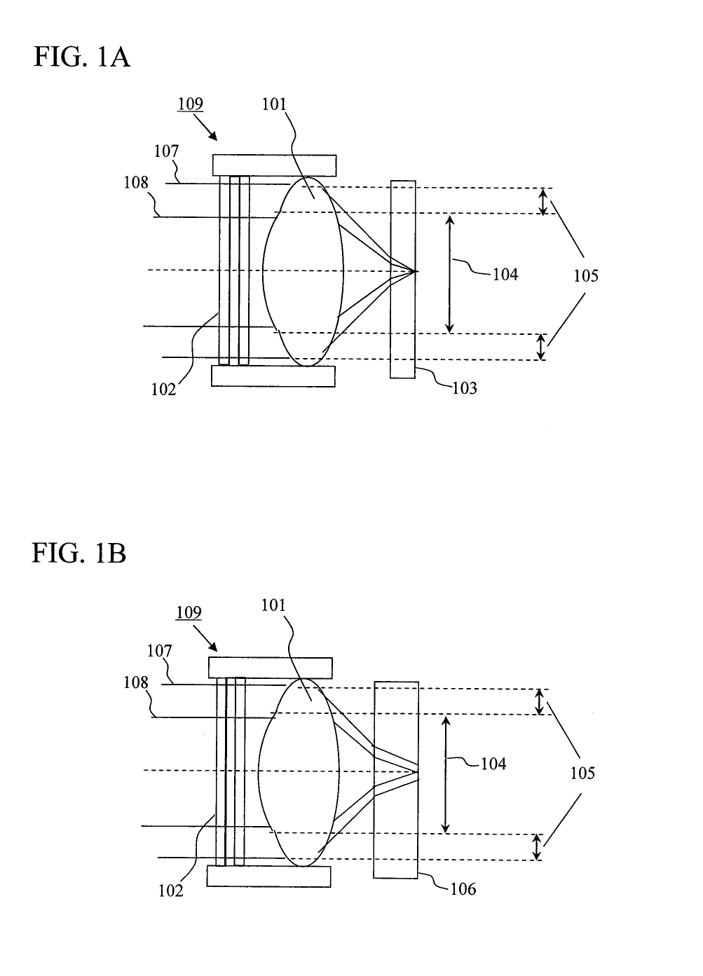

FIGS. 1A and 1B show a basic embodiment of an objective lens according to the present invention. Parallel rays 107 and 108 from a blue laser diode are incident on an objective lens 109 according to the present invention and are focused on a BD 103 as shown in FIG. 1A and on an HD 106 as shown in FIG. 1B. The objective lens 109 is configured of an aspherical lens 101 and a liquid crystal device 102. The aspherical lens 101 is in the form of an aspherical lens optimized for a substrate thickness of 0.35 mm in a BD/HD common region 104 and is in the form of an aspherical lens optimized for a substrate thickness of 0.1 mm in a BD dedicated region 105. Here, the aspherical lens 101 is configured of an aspherical surface of a second surface common to the BD/HD common region 104 and the BD dedicated region 105, and a first surface having different aspherical shapes in the respective regions. The BD has a substrate thickness of 0.1 mm, and the HD has a substrate thickness of 0.6 mm.

Thus, when light is focused on the BD 103 with the liquid crystal device 102 undriven, the ray 107 incident on the BD dedicated region 105 is focused on the BD 103 without any aberration, while the ray 108 incident on the common region 104 is subjected to spherical aberration equivalent to an error of −0.25 mm between the substrate thicknesses (0.1−0.35=−0.25 mm). Similarly, when light is focused on the HD 106, the ray 107 incident on the BD dedicated region 105 is subjected to spherical aberration equivalent to an error of 0.5 mm between the substrate thicknesses (0.6−0.1=0.5 mm), and the ray 108 incident on the common region 104 is subjected to spherical aberration equivalent to an error of 0.25 mm between the substrate thicknesses (0.6−0.35=0.25 mm). Here, however, an appropriate voltage is applied to the liquid crystal device 102 to provide satisfactory compensation for the aberration of the ray 108 in the common region both on the BD and on the HD. The ray incident on the BD dedicated region at the time of HD reproduction is subjected to the spherical aberration of great magnitude equivalent to an error of 0.5 mm between the substrate thicknesses, and is diffused around a focusing spot so as not to affect signal reproduction.

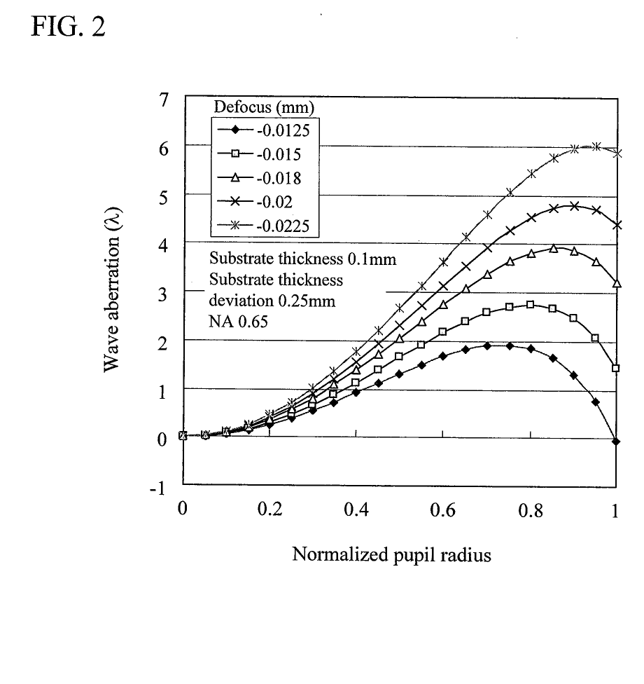

FIG. 2 is a plot showing wave aberration that occurs in an NA range of 0.65 when the above-mentioned aspherical lens 101 is used for BD reproduction. In FIG. 2, the horizontal axis indicates a normalized pupil radius within an effective pupil diameter, and the vertical axis indicates aberration. Multiple plotted curves show wave aberration profiles that appear with varying defocuses on the disc, as depicted by legends in FIG. 2. Here, wave aberration that occurs in the NA range for the HD when the above-mentioned aspherical lens 101 is used for HD reproduction is merely opposite in sign and is in the same aberration form as spherical aberration that occurs on the BD in the NA range for the HD, since the substrate thickness of the aspherical lens 101 employed in this range is of an intermediate thickness between the substrate thicknesses of the BD and the HD.

If the liquid crystal device having an annular transparent electrode is used to compensate for such wave aberrations so as to have a given peak-to-peak value, a greater degree of inclination of the wavefront leads to the electrode of narrower width. It is therefore desirable that the wavefront be in a form having the least possible degree of inclination in order to prevent the width of the electrode from becoming too narrow. According to the theory of aberration, a defocus that gives a best focus for third-order spherical aberration is in such a form that the wave aberration value on the outermost periphery of an aperture may be equal to that on the axis. Thus, in the form of wave aberration shown in FIG. 2, such a form mentioned above is close to the form that appears when the defocus is −0.0125 mm. In this instance, the required amount of aberration compensation is the smallest in FIG. 2; however, there is a great degree of inclination in the vicinity of a normalized pupil radius of 1 on the outermost periphery. Comparison with other forms of wavefront shows that the maximum degree of inclination of wavefront is the least in proximity to a defocus of −0.02 mm. In this defocus, the degree of inclination of wavefront at a normalized radius of 1 is approximately equal to the maximum degree of inclination of wavefront at a normalized radius of 0.8 or less. For this reason, when aberration compensation is performed on such a wavefront, the narrowest width of the electrode can be the greatest although the amount of aberration compensation is large.

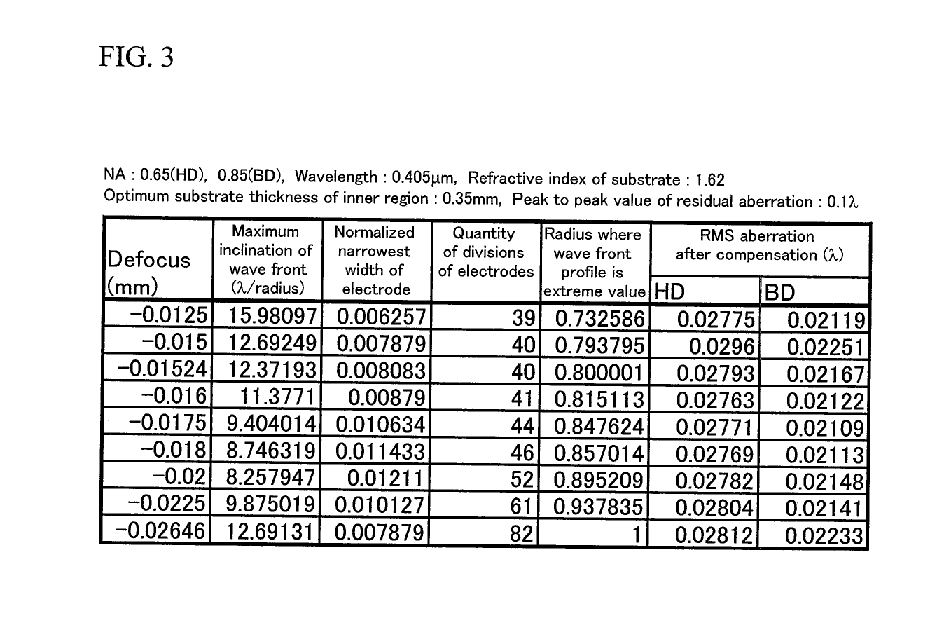

FIG. 3 is a table showing the above description numerically. Here, as for multiple defocus wavefronts including the wavefronts shown in FIG. 2, the following parameters are shown in the table: the maximum value of the degree of inclination of the wavefront; an annular width (a normalized narrowest width of the electrode) at which the peak to peak value is 0.1λ at that degree of inclination of the wavefront (hereinafter, λ represents the wavelength of the light); the quantity of divisions of annular electrodes under that condition; a normalized pupil radius where a wavefront profile is extreme value (a radius where a wavefront profile is extreme value); and RMS aberrations on the HD and the BD after compensation in a required range of NAs for the HD. The degree of inclination of the wavefront is the amount of phase shift per radius expressed in wavelength unit, and the normalized narrowest width of the electrode is the annular width normalized with the pupil radius.

From these results, it can be seen that the narrowest width of the electrode is widest when a wavefront has a defocus of −0.02 mm as described above with reference to FIG. 2, and at this time, the RMS aberration after compensation is about 0.021λ for the BD and about 0.028λ for the HD. At this time, the radius where the wavefront profile is extreme value is about 0.9, which is substantially intermediate between 0.8 and 1.0, or equivalently, this indicates that the extreme value lies between 80% and 100% in a required range of NAs for reproduction on the disc with a small NA. In addition, in the table, instances where defocus states in which the radius where the wavefront profile is extreme value is 0.8 and 1.0, that is, the defocus is −0.01524 mm and −0.02646 mm is additionally shown. It can be seen that, in this defocus range, the normalized narrowest width of the electrode is wider than the case of compensating at a defocus position of −0.0125 mm, where substantially the best focus is given before compensation. Thus, the electrode arrangement in which the wavefront of spherical aberration whose extreme value lies within such a range is compensated for aberration enables ensuring the widest possible electrode width, and thus enables applying the liquid crystal device to attain the BD/HD compatibility with a large amount of aberration compensation.

If the radius where the wavefront profile is extreme value lies between 0.8 (defocus: −0.01524 mm) and 1.0 (defocus: −0.02646 mm), the normalized narrowest width of the electrode in the table shown in FIG. 3 is about 0.008 or more, which can be larger by a factor of about 1.3 than the normalized width of the electrode of 0.006257 at the best focus position (defocus: −0.0125 mm), so that a marked improvement in manufacturing yield can be expected. For example, if the effective pupil diameter of the objective lens is set to 3 mmφ, the electrode width having a normalized width of the electrode of 0.006257 is about 9 μm, whereas the electrode width having a normalized width of the electrode of 0.008 is as wide as 12 μm. This effect is very significant in manufacture, and yield that withstands mass production can be expected in this range.

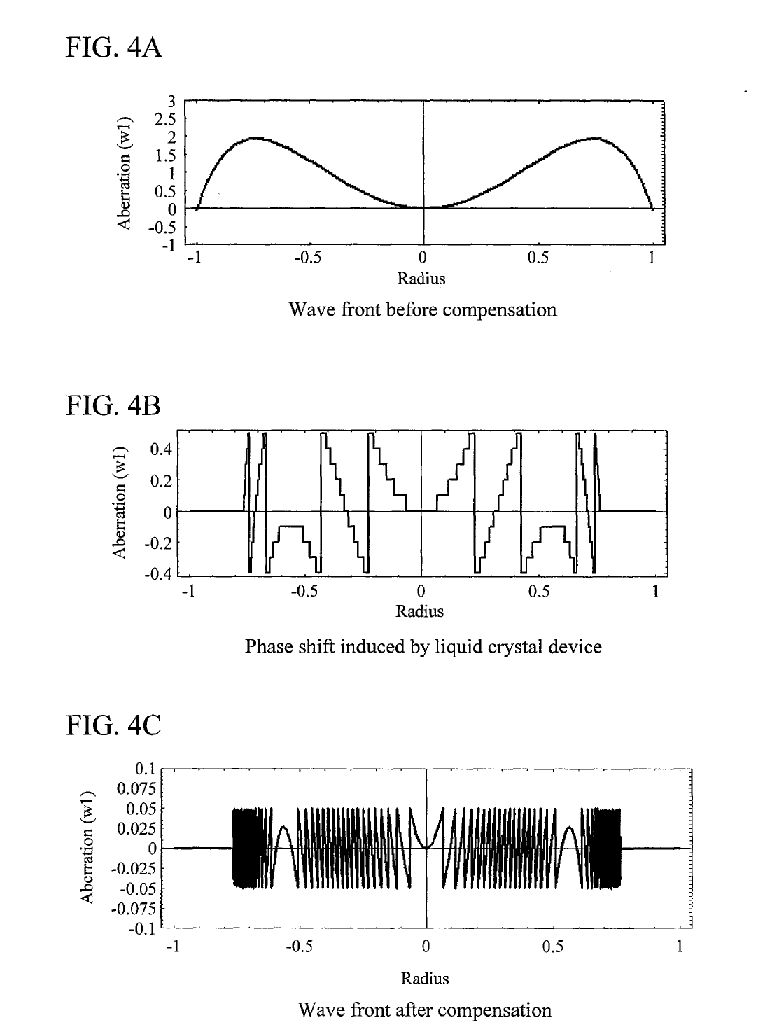

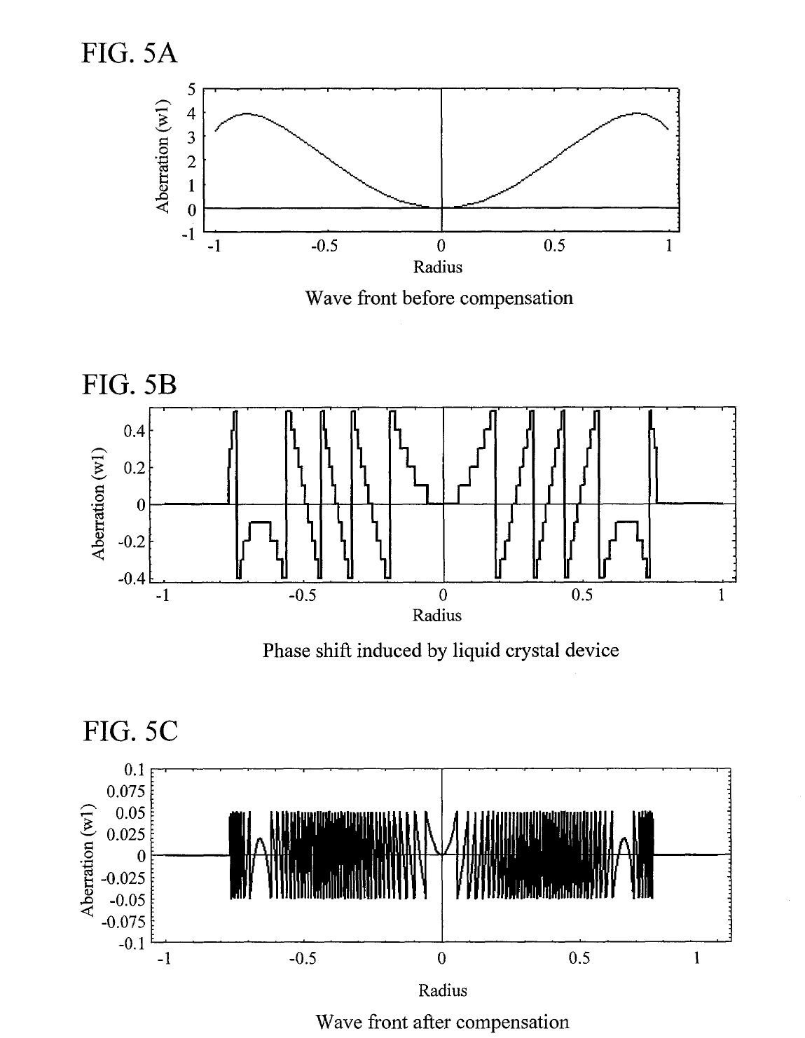

FIGS. 4A, 4B and 4C show a wavefront before compensation, a phase shift induced by a liquid crystal device, and a wavefront after compensation, respectively, when the spherical aberration wavefront at the best focus (defocus: −0.0125 mm) where the RMS aberration is the minimum is compensated for aberration by a liquid crystal device having an annular electrode pattern such that the peak to peak value of wave aberration can be 0.1λ. Likewise, FIGS. 5A to 5C show results of compensation for wave aberration given a defocus such that the extreme value of the wavefront lies between 80% and 100% inclusive in the range of NAs for HD reproduction, the compensation being performed by using a liquid crystal device having the electrode arrangement of the present invention. FIG. 5A shows the range of NAs for HD, and FIGS. 5B and 5C show the range of NAs for BD. FIGS. 4A to 4C and FIGS. 5A to 5C all show the BD reproduction; however, the aberration in the range of NAs for HD reproduction is merely opposite in sign as previously mentioned, and thus, the following description also holds true for the HD reproduction.

Comparison of FIGS. 4A to 4C and FIGS. 5A to 5C shows that, although the quantity of divisions of electrodes shown in FIGS. 5A to 5C is larger than that shown in FIGS. 4A to 4C and the phase shift induced by the liquid crystal device increases in the number of stages, the narrowest width per stage is wider. Also, here, as for the phase shift to be applied by the liquid crystal device, the phase shift to be compensated for is determined by eliminating an integer phase shift so that it can lie within ±0.5λ, even if the peak to peak value of the wavefront to be compensated exceeds 1λ. This is due to that the phase shift of an integer wavelength is equivalent to the absence of the phase shift, provided that the phase shift is equal to or less than a coherence length of laser light. When the phase shift to be applied is determined by eliminating the phase shift of the integer wavelength in this manner, there are regions to which the same common voltage is applied, and this enables narrowing the dynamic range of the phase shift to be applied and thus reducing the number of voltages to be applied. Moreover, it can be seen that the electrode having the widest width is present at a normalized pupil radius of 0.55 in FIG. 4B and at a normalized pupil radius of 0.65 in FIG. 5B, exclusive of the center. In the drawings, the horizontal axis indicates the normalized pupil radius in the range of NAs for the BD. Thus, it can be seen that, as the pupil radius in the range of NAs for the HD, this position is 0.72 in FIG. 4B and 0.85 in FIG. 5B by division by the NA ratio (0.85/0.65) and lies between 80% and 100% inclusive in the required range of NAs for HD.

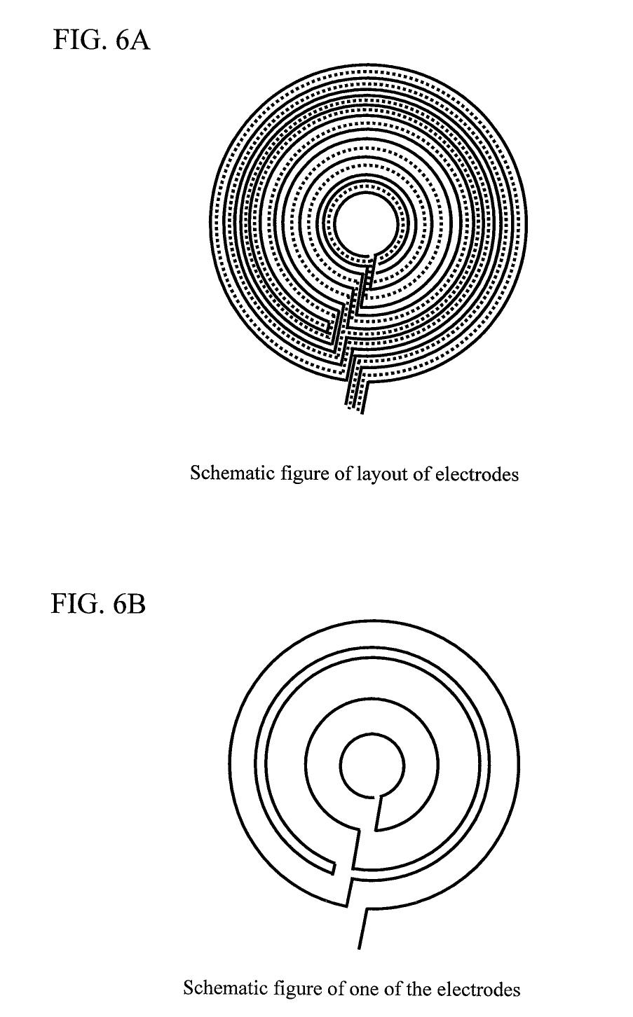

The present invention increases the number of electrodes as shown in FIG. 3, in return for expanding the narrowest width of the electrode. If such many electrodes are led out one by one from the effective pupil diameter range as in the case of the existing example disclosed in Patent Literature 5, the region occupied by the lead wires becomes large, and thus, aberration compensation performance can possibly deteriorate. For this reason, in the present invention, as shown in schematic figures in FIGS. 6A and 6B, the electrodes are led out so that the regions to be subjected to the same voltage may be connected and the regions to be subjected to different voltages may not overlap each other. FIG. 6A is the schematic figure of layout of five electrodes which are arranged in parallel and are subjected to different voltages, and FIG. 6B is the schematic figure of one of the electrodes. Note, however, that the width of the electrode and the gap between the electrodes shown in these drawings do not reflect the actual width and gap. Such a configuration enables leading out only five wires for five types of voltages, and thus enables minimizing an ineffective region caused by the electrode lead-out region. Note, however, if the electrical resistance of the transparent electrode for use is high relative to the length of the wire, the layout of the electrodes can be corrected, allowing for a voltage drop due to the length of the wire.

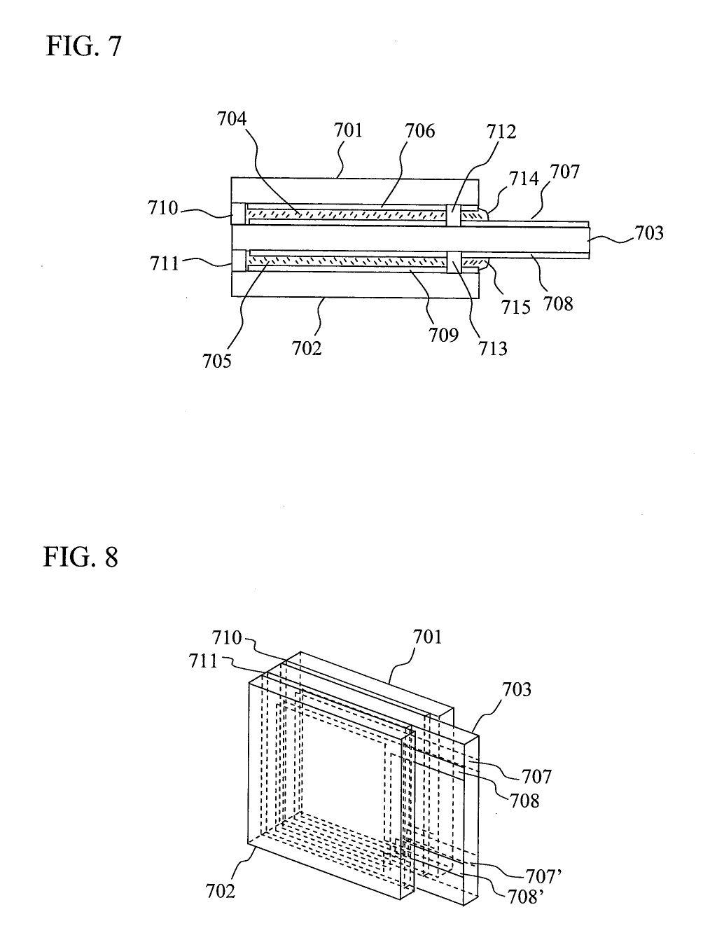

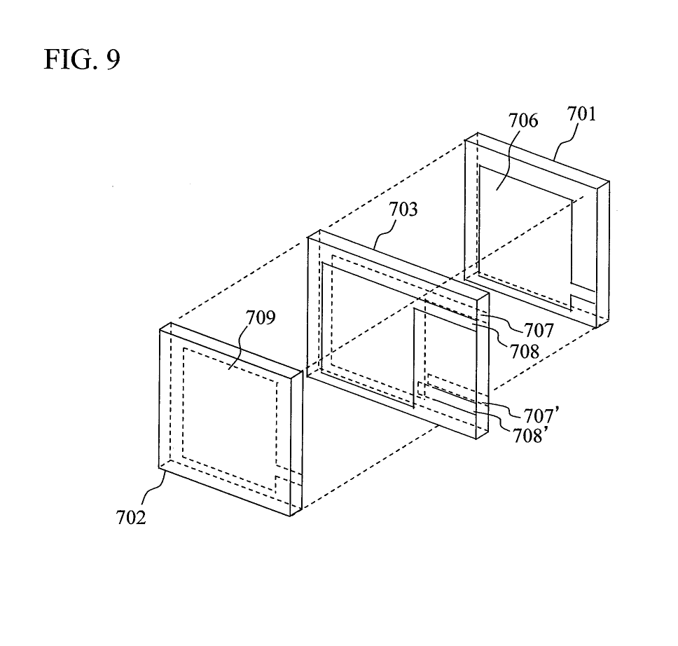

In the above embodiment, the liquid crystal device in any one of forms shown in FIGS. 7, 8 and 9 can be used. FIG. 7 is a sectional view of the liquid crystal device; FIG. 8, a perspective view thereof; and FIG. 9, an exploded view of a constituent substrates. The liquid crystal device is basically configured of three glass substrates 701, 702 and 703, and liquid crystals 704 and 705 are sealed between the glass substrates, the liquid crystals being oriented in a direction perpendicular to one another. Transparent electrodes 706, 707, 708 and 709 are formed by patterning on the surfaces of the substrates facing the liquid crystals. The electrodes 706 and 709 of the glass substrates 701 and 702 are conducted with the electrode on the central glass substrate 703 by conductive adhesives 714 and 715, and all of the electrode wires are finally connected to the outside from terminal portions (not shown) on both surfaces of the glass substrate 703 through a flexible plastic cable or the like. Reference numerals 710, 711, 712 and 713 denote sealants with which the liquid crystal device is sealed.

FIGS. 8 and 9 show only the schematic views for sake of simplicity. However, actually, an annular electrode pattern to which a voltage distribution shown in FIG. 5B is applied is formed by patterning on any one of the electrodes 706 and 707 and on any one of the electrodes 708 and 709, along with the wires arranged as shown in FIG. 6. The other of the electrodes 706 and 707 and the other of the electrodes 708 and 709 can be each of a uniform single electrode structure to which a bias voltage is applied, or can be used as the electrode for compensating for different aberration from spherical aberration to be compensated for in order to provide the compatibility between BD and HD. However, it is desirable that two electrodes have the same pattern for the following reason. The reason for two liquid crystal layers is that a linearly polarized light component in one predetermined direction is typically compensated for aberration by the liquid crystal.

A pickup of the optical disc requires disposing a beam splitter for guiding reflected light from the disc to the photodetector in an optical path from the laser diode to the objective lens. A polarization beam splitter is used particularly for a recording pickup, and a quarter wave plate is also disposed in an optical path between the polarization beam splitter and the objective lens. Thereby, light from the laser diode passes through the polarization beam splitter with nearly 100% efficiency, and the reflected light from the disc is reflected by the polarization beam splitter with nearly 100% efficiency, so that the utilization efficiency of light can be enhanced, as compared to the use of a non-polarization beam splitter.

In such an optical system, in an optical path from the polarization beam splitter to the quarter wave plate, the direction of polarization of linearly polarized light in a forward way is perpendicular to that in a backward way, and thus, if the liquid crystal device is disposed here, aberration compensation acts only on the forward way. This is due to the fact that if the aberration compensation acts on the backward way the spot on the disc deteriorates by the aberration, and thus, the liquid crystal is useless unless the aberration compensation acts on the forward way, provided that the aberration compensation acts only on any one of the forward and backward ways. However, when the aberration compensation does not act on the backward way, no compensation is provided for spherical aberration produced in the process of light being reflected by the recording film of the optical disc, passing through the objective lens and returning to the optical system. This can possibly cause deterioration in a defocus signal or a tracking signal and thus impair stable servo control. In particular, the amount of aberration compensation for the compatibility between BD and HD is larger than that of simple compensation caused by an error between the substrate thicknesses, and thus, the influence thereof is serious. For this reason, here, in order that aberration compensation is performed in the backward way in addition to the forward way, two liquid crystal layers are oriented by the rubbing process in directions perpendicular to each other to provide aberration compensation for both linearly polarized light components. Thus, it is required that one of two electrode patterns between which one layer of the liquid crystals is sandwiched be disposed so as not to be misaligned with respect to the other two electrode patterns between which the other layer of the liquid crystals is sandwiched.

Both the BD and HD have a dual disc standard, and, for reproduction on these discs, it is appropriate that a typical spherical aberration compensation pattern is employed as an aberration compensation pattern other than a spherical aberration compensation pattern for attaining the compatibility between BD and HD. For aberration compensation between two layers, for example for the BD, the gap between the layers is 25 μm, and thus, the amount of spherical aberration is of the order of about 0.8λ p-p. Accordingly, an existing electrode pattern that does not have a fine electrode structure such as the present invention may be used.

Further, as mentioned above, in the case of using a dual-layer liquid crystal device, it is essential that the quarter wave plate is interposed between the polarization beam splitter and the objective lens, of the pickup optical system. Locating the quarter wave plate toward the objective lens relative to the liquid crystal device is the same in principle as locating the quarter wave plate toward the polarization beam splitter relative to the liquid crystal device. However, it is desirable that the quarter wave plate be interposed toward the objective lens so that light can be linearly polarized light when passing through the liquid crystal device, allowing for misalignment between the relative positions of the transparent electrodes acting on two liquid crystal devices. At this time, one of the glass substrates 701 and 702, which is located toward the objective lens, shown in FIG. 7 can be used as the quarter wave plate. If the quarter wave plate using structural anisotropy by a periodic structure of a wavelength or less is used, the quarter wave plate can be practically used by patterning of a dielectric grating on the glass substrate.

Also, in FIG. 9, electrodes 707′ and 708′ are electrode terminals that provide continuity from the electrodes 706 and 709 on the surfaces of the glass substrates 701 and 702, both facing the glass substrate 703, to the glass substrate 703 through an anisotropic conductive adhesive (not shown). Incidentally, these electrodes are schematically shown in simplified form, actually typifying multiple electrode wires for aberration compensation according to the present invention.

### Second Embodiment

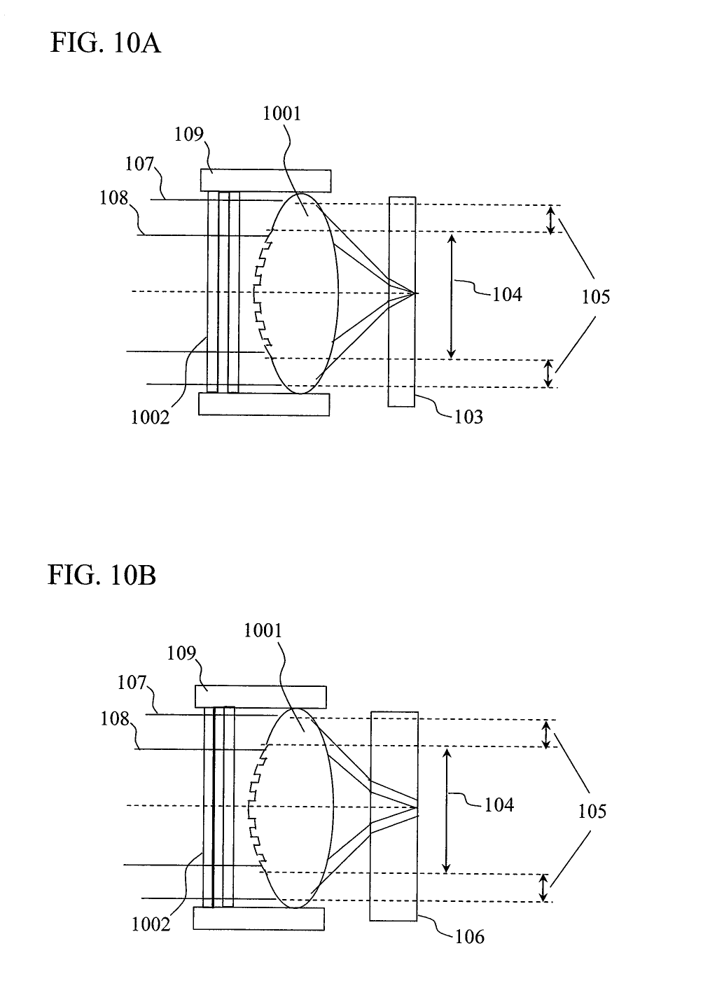

FIGS. 10A and 10B show a second embodiment of the objective lens according to the present invention. FIGS. 10A and 10B show BD reproduction and HD reproduction, corresponding to FIGS. 1A and 1B, respectively. Here, an aspherical lens 1001 with an annular groove is used as the aspherical lens. This groove has a depth having the function of advancing by half of a wavelength a phase shift of light transmitting through the groove with respect to light transmitting outside the groove. Specifically, the depth is given by λ/{2(n−1)}, where n denotes the refractive index of a material for the lens.

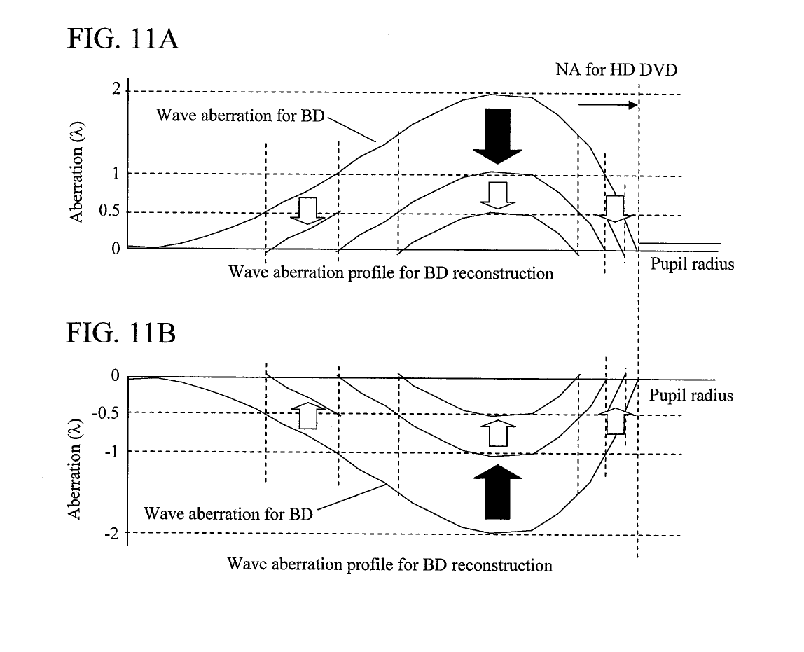

The effect of this configuration will be described with reference to FIGS. 11A and 11B. As previously mentioned, in the present invention, the aspherical lens has the aspherical shape employed in the NA range for the HD reproduction for the intermediate substrate thickness between the substrate thicknesses of the BD and the HD so as to compensate for spherical aberration. Thus, as shown in FIGS. 11A and 11B, in the NA range for the HD, the wave aberration that occurs during BD reproduction, as shown in FIG. 6A, is in the same aberration form as and is merely of opposite sign to the wave aberration that occurs during HD reproduction, as shown in FIG. 6B. At this time, the phase shift of an integer wavelength is equivalent to the absence of the phase shift within the range of the coherence length of a light source of the laser diode. Thus, the aberration can be shifted from the original wavefront on the BD and the HD, as shown by the black arrows. Further, when the aberration is 0.5λ or more, a step structure is used to shift the aberration on the BD by 0.5λ as shown by the white arrow, and likewise, the step structure is used to shift by 0.5λ the aberration on the HD designed for reproduction at the same wavelength.

Here, assuming that the direction of shift is the minus direction in the drawing as in the case of the BD, this direction appears to the direction in which the aberration increases; however, with application of the theory that “the phase shift of an integer wavelength is equivalent to the absence of the phase shift,” this can be equivalent to that a shift of −0.5λ and a shift of +1λ are given at the same time, and thus, eventually, this is equivalent to a phase shift of +0.5λ. Thus, the aberration wavefront is shifted in the direction of the white arrow also on the HD, so that a phase shift of 0.5λ can reduce the wave aberration to the range of 0.5λ p-p both on the BD and on the HD. Naturally, this is insufficient for aberration compensation for the compatibility between BD and HD, and thus, in addition to this, the liquid crystal device provides aberration compensation as shown in FIGS. 10A and 10B.

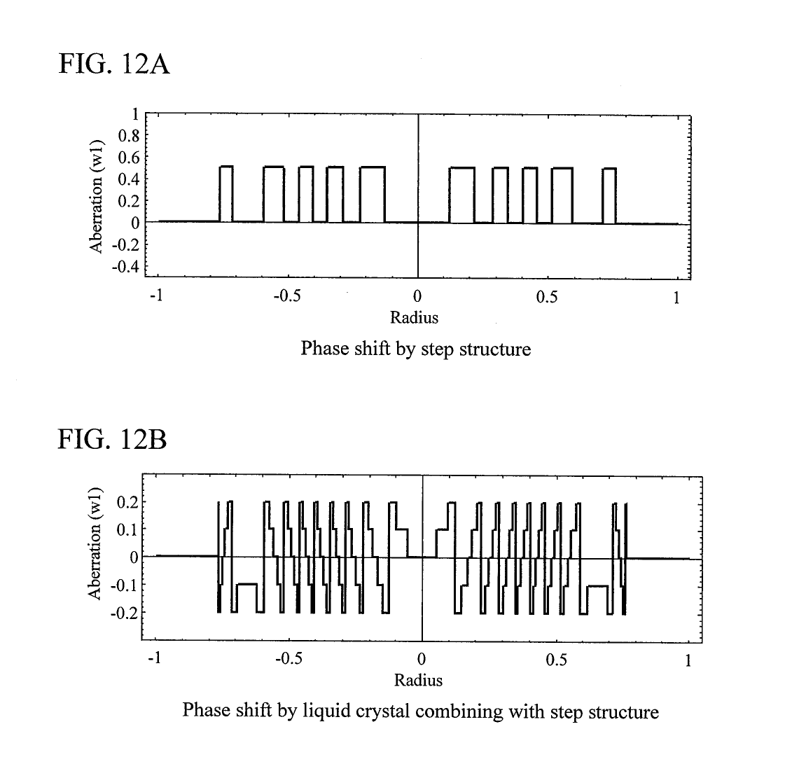

FIGS. 12A and 12B show the distribution of the amount of phase shift according to the second embodiment. Here shown is the case of compensating for the aberration wavefront in the required NA range for the HD shown in FIG. 5A. FIG. 12A shows the phase shift by a step structure, and FIG. 12B shows the phase shift by the liquid crystal combining with the step structure. As compared to FIG. 5B, it can be seen that the width of the electrode does not change, while the level of voltage to be applied to the liquid crystal is level 5, which is half of level 10 in FIG. 5B. The wavefront after compensation is the same as shown in FIG. 5C. This enables reducing the level of voltage to be applied to the liquid crystal, thus reducing the number of wires to the liquid crystal device, also reducing the number of wires led from the incoming region of light of the liquid crystal device, thus reducing the area of the region occupied by the lead electrodes, and thus enhancing the effect of reducing aberration. Such a phase step is not necessarily limited to the groove in the surface of the lens, and a dielectric material may be vapor or sputter deposited on the surface of the glass substrate of the liquid crystal device to thereby produce an equivalent effect.

Also, FIG. 12B shows the amount of phase shift by the liquid crystal for BD reproduction; however, it is needless to say that, for HD reproduction, the phase shift of the same waveform and the opposite sign may be given. Also, the annular electrode of the greatest width, exclusive of the electrode at the center, is located at a normalized pupil radius of about 0.65 in the NA range for the BD, or equivalently, at an 85% position in the NA range for the HD, as in the case of FIG. 5B.

The present invention can provide a BD/HD-compatible lens, thus eliminating confusion in the market due to the fact that the standard of large-capacity optical disc is divided into two, thereby eliminating consumer's concerns, and thus invigorating the market for HDTV video.

### EXPLANATION OF REFERENCE NUMERALS

101 . . . aspherical lens
102 . . . liquid crystal device
103 . . . BD
104 . . . BD/HD common region
105 . . . BD dedicated region
106 . . . HD
107, 108 . . . parallel rays
109 . . . objective lens
701, 702, 703 . . . glass substrates
704, 705 . . . liquid crystals
706, 707, 707′, 708, 708′, 709 . . . transparent electrodes
710, 711, 712, 713 . . . sealants
714, 715 . . . anisotropic conductive adhesives
1001 . . . aspherical lens with annular groove
1002 . . . liquid crystal device

1. An objective lens that selectively focuses light from a laser diode on a first optical disc having a first recording density and a first substrate thickness, and on a second optical disc having a second recording density lower than the first recording density and a second substrate thickness greater than the first substrate thickness, the objective lens comprising:
a first numerical aperture required for focusing the light on the first optical disc;
an aspherical shape in a range of a second numerical aperture required for focusing the light on the second optical disc, the second numerical aperture being smaller than the first numerical aperture, the aspherical shape configured to compensate for spherical aberration for an intermediate substrate thickness between the first substrate thickness and the second substrate thickness;
an aspherical shape outside the range of the second numerical aperture and within a range of the first numerical aperture, the aspherical shape configured to compensate for spherical aberration for the first substrate thickness;
a means formed integrally with the objective lens in the range of the second numerical aperture, the means having an annular region that provides transmitted light with a phase shift of approximately m/n of the wavelength of the laser diode (where n denotes a natural number that satisfies a formula n≧2, and m denotes an integer that satisfies a formula |m|≦n/2), and the means configured to change the sign of the phase shift so that the sign for the first optical disc is substantially opposite to the sign for the second optical disc.

2. The objective lens according to claim 1, wherein n is equal to 2 (n=2), and the phase shift is induced by a step structure provided on the surface of an optical element that constitutes the objective lens.

3. The objective lens according to claim 1, wherein
the phase shift is induced by a liquid crystal device formed integrally with the objective lens, and
a voltage applied to a transparent electrode provided in the liquid crystal device is different between a case where light from the laser diode is focused on the first optical disc and a case where the light from the laser diode is focused on the second optical disc.

4. The objective lens according to claim 1, wherein
the phase shift is induced by a liquid crystal device formed integrally with the objective lens and any one of a step structure and a graded index device that effects a phase shift of plus or minus half wave, and
a voltage applied to a transparent electrode provided in the liquid crystal device is different between a case where light from the laser diode is focused on the first optical disc and a case where the light from the laser diode is focused on the second optical disc.

5. The objective lens according to claim 3, wherein
a plurality of the transparent electrodes are annularly formed, and
an annular electrode of the greatest width among the transparent electrodes exclusive of electrodes at the center and outside the range of the second numerical aperture, is present in a radial location that lies from 80% to 100%, both inclusive, of the second numerical aperture.

6. The objective lens according to claim 3, wherein
a plurality of the transparent electrodes are annularly formed;
the plurality of transparent electrodes called annular electrodes are disposed in the liquid crystal device to lead each of wires outside a region that transmits by providing junctions between the plurality of annular electrodes, to which an equal voltage is to be applied, in a way that:
supposing that the annular electrodes includes a first annular electrode and a second annular electrode located outside the first electrode, the first and second annular electrodes being in proximity to each other and being to receive an equal voltage; a third annular electrode located between the first and second annular electrodes and being to receive a voltage different from the voltage applied to the first and second annular electrodes; and a fourth annular electrode located outside the second annular electrode, being in proximity to the third annular electrode, and being to receive a voltage equal to the voltage applied to the third annular electrode,
a first node electrode is disposed as a substantially radial and linear junction to connect the first annular electrode and the second annular electrode through a broken portion provided to the third annular electrode, and
a second node electrode is disposed, substantially in parallel to the first node electrode, as a junction to connect the third annular electrode and the fourth annular electrode through a broken portion provided to the second annular electrode.
